(19) United States
(12) Patent Application Publication
(10) Pub. No.: US 2024/0353980 A1
(43) Pub. Date: Oct. 24, 2024

(54) GRAPHICAL USER INTERFACE AND METHODS FOR ORGANIZING INFORMATION FOR AND FROM AN AI ENGINE IN A VIRTUAL CANVAS

(71) Applicant: T1V, INC., Charlotte, NC (US)

(72) Inventors: James E. MORRIS, Lake Wylie, NC (US); Michael R. FELDMAN, Charlotte, NC (US); Ron GILSON, Cornelius, NC (US)

(73) Assignee: T1V, INC., Charlotte, NC (US)

(21) Appl. No.: 18/639,210

(22) Filed: Apr. 18, 2024

Related U.S. Application Data
(60) Provisional application No. 63/460,132, filed on Apr. 18, 2023.

(51) Int. Cl. G06F 3/0484; G06F 3/0483; G06F 3/14

(52) U.S. Cl. CPC G06F 3/0484; G06F 3/0483; G06F 3/1454

(57) ABSTRACT

A method of using an artificial intelligence engine in a virtual canvas running on a computer associated with a display, the method including starting a virtual canvas on the computer, in response to an artificial intelligence icon being selected in an icon window of the virtual canvas, open a prompt tab to receive a prompt input, and in response to the prompt input and activation of a button, generate a response from an artificial intelligence engine in the prompt tab or in a new window on the canvas.

### CROSS-REFERENCE TO RELATED APPLICATION

The present application claims priority to Provisional Ser. No. 63/460,132 filed on Apr. 18, 2023, the entire contents of which are hereby incorporated by reference.

### BACKGROUND

The present disclosure relates to an interface and method for interacting with an artificial intelligence engine on a virtual canvas.

### SUMMARY

One or more embodiments are directed to a method of collaborating between a first computer associated with a first display at a first location and a second computer associated with a second display at a second location, the method including establishing a connection between the first and second computers, starting a virtual canvas on the first computer, sending the virtual canvas from the first computer to the second computer, in response to an artificial intelligence icon being selected on the first computer or the second computer, open a prompt tab to receive a prompt input, and in response to the prompt input and activation of a button, generate a response from an artificial intelligence engine in the prompt tab or in a new window on the canvas.

One or more embodiments are directed to a method of using an artificial intelligence engine in a virtual canvas running on a computer associated with a display, the method including starting a virtual canvas on the computer, in response to an artificial intelligence icon being selected in an icon window of the virtual canvas, open a prompt tab to receive a prompt input, and in response to the prompt input and activation of a button, generate a response from an artificial intelligence engine in the prompt tab or in a new window on the canvas.

The prompt input may be text or a sketch.

Each window on the canvas generated from the artificial intelligence engine may include a ranking metric for selection by a user.

In response to a user ranking one more windows generated from the artificial intelligence engine on the canvas, feeding back the ranked windows to the artificial intelligence engine.

One or more embodiments are directed to a graphical user interface for using an artificial intelligence engine in a virtual canvas running on a computer associated with a display, the graphical user interface being displayed in response to an artificial intelligence icon being selected in an icon window of the virtual canvas. The graphical user interface may include a prompt tab for inputting a single prompt to retrieve a single text result from an artificial intelligence engine, a notes tab for inputting a single prompt to retrieve more than one text result from the artificial intelligence engine, and a media tab for inputting a single prompt to retrieve one or more images from the artificial intelligence engine.

In response to the prompt being input to the prompt tab, the GUI displays the single text result in the prompt tab, in response to the prompt being input to the notes tab, the GUI displays reach text result in a separate window on the canvas, and in response to the prompt being input to the media tab, the GUI displays each image result in a separate window on the canvas.

### BRIEF DESCRIPTION OF THE DRAWINGS

The scope of the present disclosure is best understood from the following detailed description of exemplary embodiments when read in conjunction with the accompanying drawings.

FIG. 1 is a configuration used to establish a connection between two computers and create a virtual canvas.

FIG. 2 is a virtual canvas window and icons associated therewith.

FIG. 3 is virtual canvas window displayed when an AI icon is selected.

FIG. 4 is a plurality of images generated by entering a prompt in the virtual canvas window activated as an AI engine prompt and selection thereof.

FIG. 5 is a plurality of images generated by entering a prompt in the virtual canvas window activated as an AI engine prompt and ranking thereof.

FIG. 6 is a plurality of images generated by entering a prompt in the virtual canvas window activated as an AI engine prompt and ranking thereof.

FIG. 7 is a plurality of images generated by entering a prompt in the virtual canvas window activated as an AI engine prompt and ranking thereof.

FIG. 8 is an interface including an AI icon for the canvas, rather than a particular virtual canvas window.

FIGS. 9-12 are interfaces to be displayed in response to an AI icon for the canvas being selected.

### DETAILED DESCRIPTION

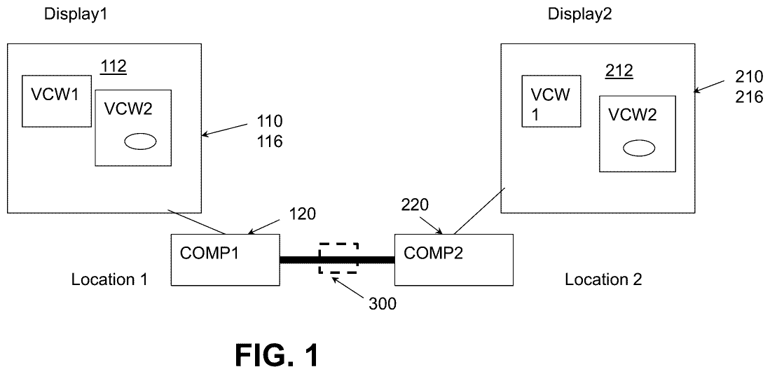

As illustrated in FIG. 1, when operating at multiple locations, here illustrated as two for simplicity, when the screen on the displays is treated as a virtual canvas, rather than an entire screen, as disclosed, for example, in U.S. Pat. No. 9,596,319, issued on Mar. 14, 2017, which is hereby incorporated by reference for all purposes, individual objects or windows on the virtual canvas on a display Display1 110 at a first location Location 1 running on a first computer COMP1 120 may be transferred to a second computer COMP2 220 associated with a display Display2 210 at a second location Location 2 to be displayed on a virtual canvas on the display Display2 210, and vice versa. Instead of storing the objects or windows in the cloud, a shared canvas may be established to be accessed by both computers COMP1 120 and COMP2 220 running the displays using the virtual canvas software noted below and the objects can be transferred directly, e.g., using a peer-to-peer connection. This peer-to-peer connection may be established through a relay server, e.g., in the cloud, which does not store anything, but just relays that data or the connection may be direct peer-to-peer without going through a relay server.

As used herein, peer-to-peer connection means that the computers forming the peer-to-peer connection communicate with each other, either directly or through a relay server 300. When the relay server 300 is used, the relay server 300 just relays data in real time to facilitate the communication, but does not rely on storing data to transfer information. In contrast, in cloud-based communication protocol, each local computer communicates information to a cloud-based server. The cloud-based server has the master information or the master canvas and all objects on the canvas. Periodically, each local computer requests from the cloud server if any changes have been made to the master canvas and if so, a synchronization occurs between the local computer and the cloud server.

In accordance with embodiments, initially a virtual session is started at a first location, with a computer, e.g., Comp1 120 or Comp2 220, that is running virtual canvas software, i.e., a canvas APP, e.g., ThinkHub® multi-site software by TIV®. In particular, a virtual canvas that exists within the software that may be much larger than the physical display region 112, 212 on Display1 110, 210. Any section of the virtual canvas can be viewed on the display region 112, 212 of the Display1 110, 210. Suppose that at first the entire virtual canvas is viewed on the display region 112, 212 and that each of the displays 110, 210 include a touch or gesture sensor 116, 216 associated therewith. Then by zooming into regions, a portion of the virtual canvas can be viewed. By pinching, zooming and panning with gestures detected by the touch sensor 116, 216, a user can zoom into various regions of the virtual canvas to be shown on the display region 112, 212.

The virtual canvas is a virtual region that expands to greater than the physical area of the display regions 112, 212, e.g., any number of times the physical area up to infinite. The use of the virtual canvas allows additional files to be accessible and can be saved, but off the display regions 112, 212. Gestures, such as pan, zoom and pinch gestures can be made to move and resize the scale of the virtual canvas, allowing the full canvas to be displayed all at once or only a small section thereof.

After connection is established, then a user, e.g., at Comp1 120 starts a multisite session and gives it a name. Then, a user at a second location with a computer, e.g., Comp 2 220, that is also running the virtual canvas software can see a list of active multisite sessions that it has permission to access. Then, the user at the second location taps on a button or on the name in the list on the virtual canvas to join the session. Once the second computer joins the session, the connection is established between Comp1 and Comp2, and the data for all the objects on Comp1 in the virtual canvas is then sent to Comp 2, and vice versa, such that the virtual canvas is now a shared canvas. For example, when a window VCW1 is opened in Display1 at Location 1, the window VCW1 will also appear in Display 2 at Location 2, and, when a window VCW2 is opened in Display2 at Location 2, the window VCW2 will also appear in Display 2 at Location 2. From this point forward, any time a user on either computer (Comp1 or Comp 2) enters any data onto the canvas or opens a new window, the entire data or window is transmitted to the other computer, so that at any time after the initial set-up all objects in either display are stored locally on both computers. Further, objects are at a single location on the shared canvas, and objects on the shared canvas can be manipulated from both the first and second display computers simultaneously. File-based objects can be displayed and edited by both sides simultaneously by exchanging all file-based data about the object with both sides and any changes are exchanged in real time. Examples of file-based objects are notes, images, sketches and pdf files. These can be accessed and manipulated with native apps built into the canvas software, for example a Note App, Sketch App, image viewer or pdf viewer. Live Source objects may change continuously and may be edited or changed outside of the canvas APP. For example, if the Canvas is closed and reopened later, the live source object may be different. What is stored on the Canvas is the metadata, e.g., the location of the live source object on the canvas and a pointer to the source of the live source object. For file-based objects, the entire file is saved on the canvas and the object information for that file can only be changed within the canvas App: a file-based object is changed on one computer within the canvas App and then updated on the virtual canvas stored in the cloud and then all computers that connect to the Canvas receive the updated file information.

Native objects are objects that are controlled within the application APP, e.g., a sketch, a note, objects, pdf viewer, image viewer, and so forth. While the above has shown the displays displaying the objects at the same locations on the two displays, this is true if the displays are both displaying the same views of the canvas. In other words, while the objects are at the same location on the canvas, different views of the canvas may be viewed on the different displays. For example, if Display 2 were viewing the same general region of the virtual canvas, but with a different zoom factor and slightly different center point, then on Display 2 VCW1 and VCW2 would appear on the same places on the virtual canvas but different locations on the Display and with different scale factors. Further, one display may be viewing a different portion of the shared canvas without altering the view on the other display. Alternatively, changing portions being viewed on one display may alter that view on the other display.

U.S. Pat. Nos. 11,729,355 and 11,709,647, both of which are incorporated herein by reference in their entirety for all purposes, disclose the use of a canvas in which various types of windows are displayed with various manners in which to interact with these different types of windows. A Canvas is a virtual region that expands to greater than the physical area of a display region of a display, e.g., any number of times the physical area up to infinite. The use of the Canvas allows additional files to be accessible and can be saved, but off the display region. Further discussion of the canvas may be found in U.S. Pat. No. 9,596,319, which is hereby incorporated by reference in its entirety for all purposes. Gestures, such as pan, zoom and pinch gestures can be made to move and resize the scale of the Canvas, allowing the full canvas to be displayed at once or only a small section thereof, while gestures associated with a particular window may be used pan, zoom and pinch gestures can be made to move and resize only that window. Further, tapping or otherwise selecting that window may bring up menus or window trays associated with that window adjacent to that window, in accordance with a type of window These different types of windows may windows that display one of a mobile device stream, a white board, a video conference stream, a browser stream, a snapshot of a stream, and the like. The window trays may include annotation tool, a virtual keyboard tool, a snapshot tool, and the like. Such a canvas may be used with only one user, i.e.,

With the introduction of numerous AI engines that allow images to be retrieved or created in response to user input, e.g., text, a way to efficiently select and refine the image output may be needed. The use of an AI engine within a canvas may allow such refinement to be readily achieved. Further, while the use of a virtual canvas is described above regarding facilitating collaboration between remote users, a canvas for use by a single user may also allow ease of using an AI engine.

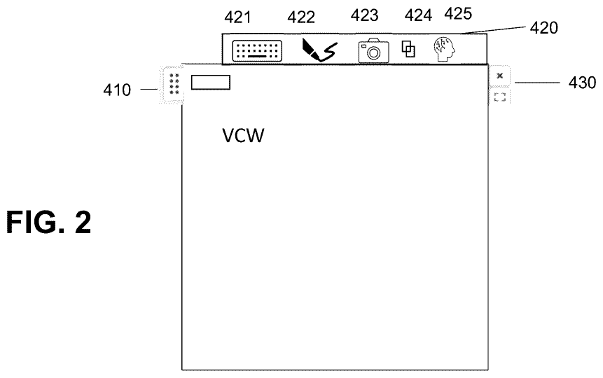

A detailed view of a virtual canvas window VCW is shown in FIG. 2, in which the VCW is a sketchpad. In addition to the functions that may be applied to the canvas discussed above, functions directed to just the VCW may be adjacent to the VCW. These functions may similarly be provided on any type of window on the canvas, e.g., a browser application, an image window, a live source window, and the like, as appropriate. For example, the VCW may include a handle 410 that allows for easier grabbing of the VCW, an interactive menu 420 that allows for various interaction with the VCW, and a size menu 430 that allows the VCW to be closed or expand to full screen. As shown therein, the interactive menu 420 may include a keyboard icon 421 that brings up a virtual keyboard, a sketch icon 422 that allows sketching, a snapshot icon 423 that takes a snapshot of the VCW, a front//back icon 424 that brings the VCW forwards or backwards, and an AI icon 425 that sends information on the sketchpad, e.g., text or a sketch in the VCW, to an associated AI engine that retrieves and/or generates images based on the text.

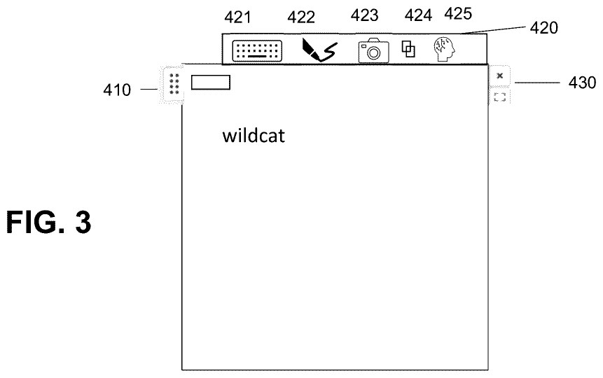

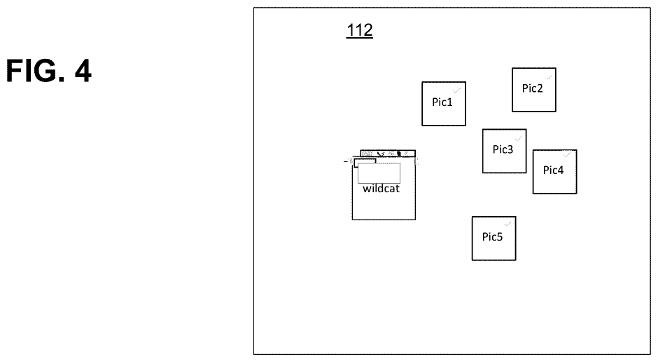

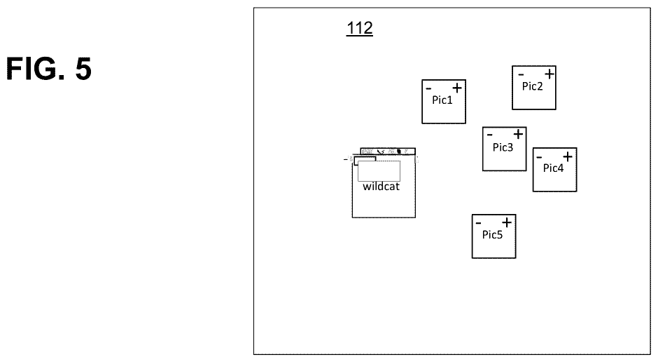

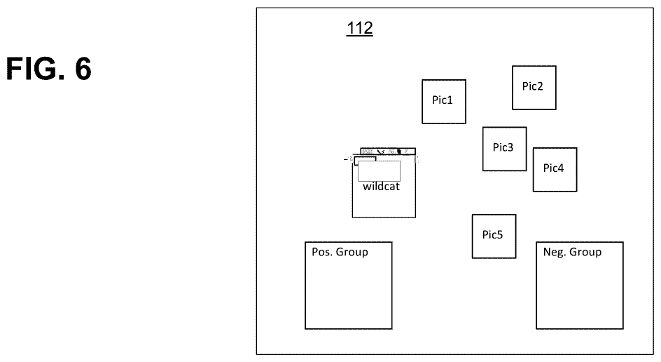

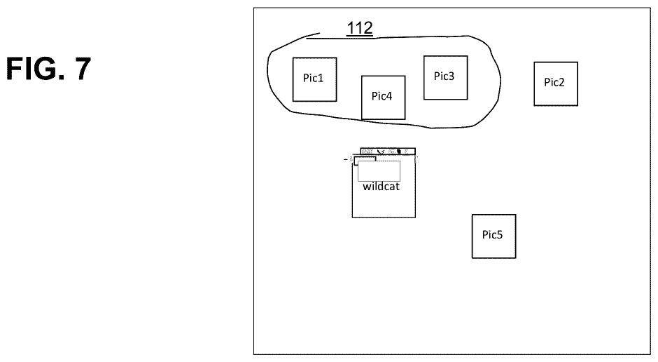

As shown in FIG. 3, when text or sketch or other image is provided in the VCW, the AI icon 425 may be selected, which then outputs multiple individual pictures, e.g., Pic1-Pic5 shown in FIG. 4, on the canvas associated with that VCW. A user may then move, rotate, or resize each picture and may select individual pictures, e.g., by highlighting a check mark in each picture and activate the AI icon again to refine the image output or by dragging the picture to the associated VCW, and activate the AI icon again using the multiple pictures to refine the image output. Alternatively, a maximum number of selections may be permitted and, once this number is met, automatically running the AI engine again. As another alternative, as shown in FIG. 5, each picture may include a positive ranking icon and a negative ranking icon, which can be clicked once for selection or multiple, e.g., three times, to indicate degree of positive/negative ranking, dragged to the VCW or just activate the AI icon again. Further alternatives to selecting images is shown, e.g., in FIG. 6-. In FIG. 6, the images to be selected as clustered together and encircled to indicate selection and then activating the AI icon again. In FIG. 7, images are dropped in a positive group window for the VCW or a negative group window for the VCW, and then activating the AI icon again.

This may be repeated numerous times until a desired image(s) is output. This improves the convenience of interacting with the AI engine and allows refinement to be quickly realized.

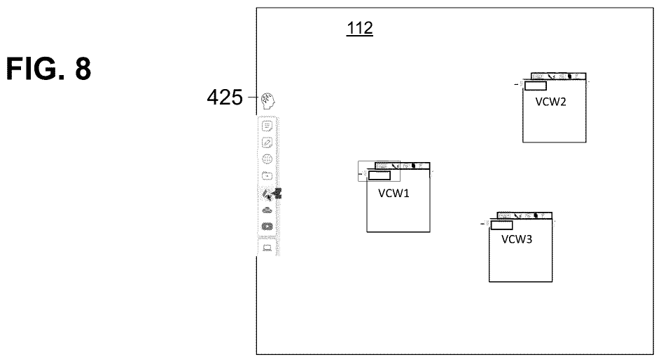

As a further alternative, as shown in FIG. 8, AI mode may be provided for the canvas itself. In other words, on the panel for the canvas, in addition to icon for creating a notepad, annotating, opening a browser window, and so forth, may include an AI icon. When activated, the AI icon may instruct an AI engine to run on all information in the VCWs in view to retrieve or create appropriate images.

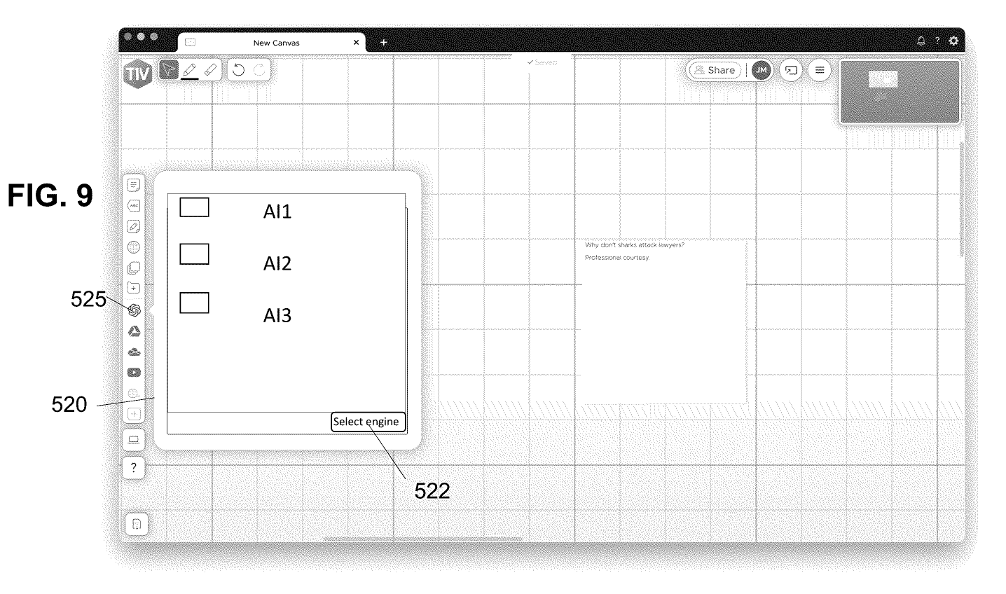

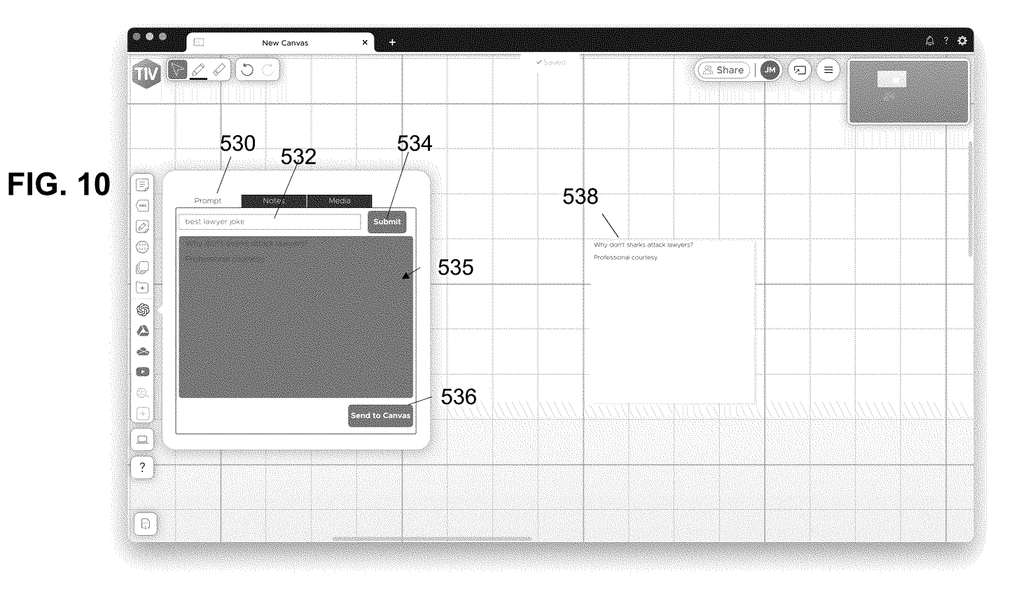

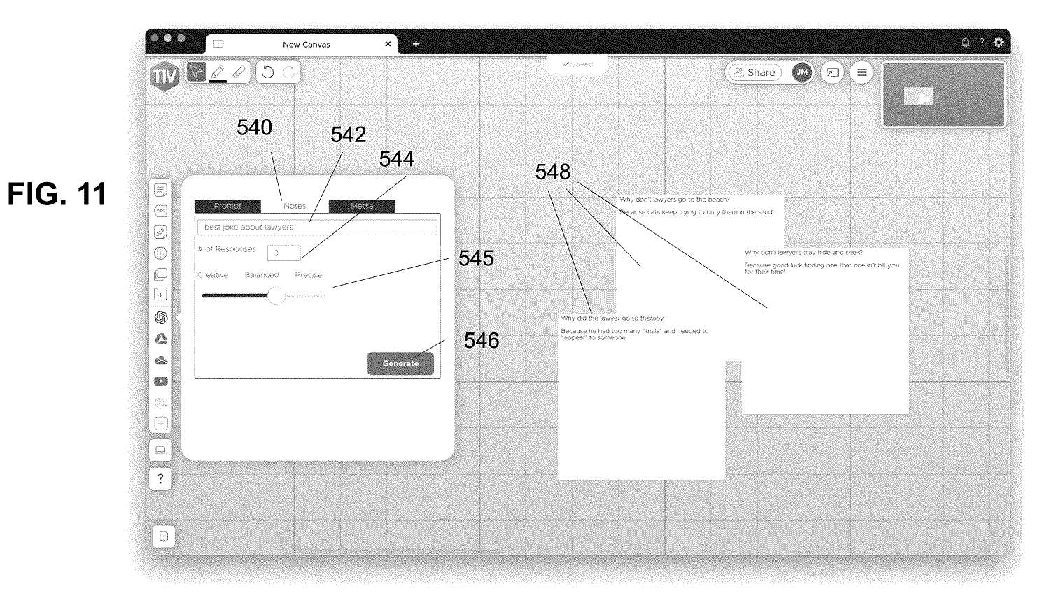

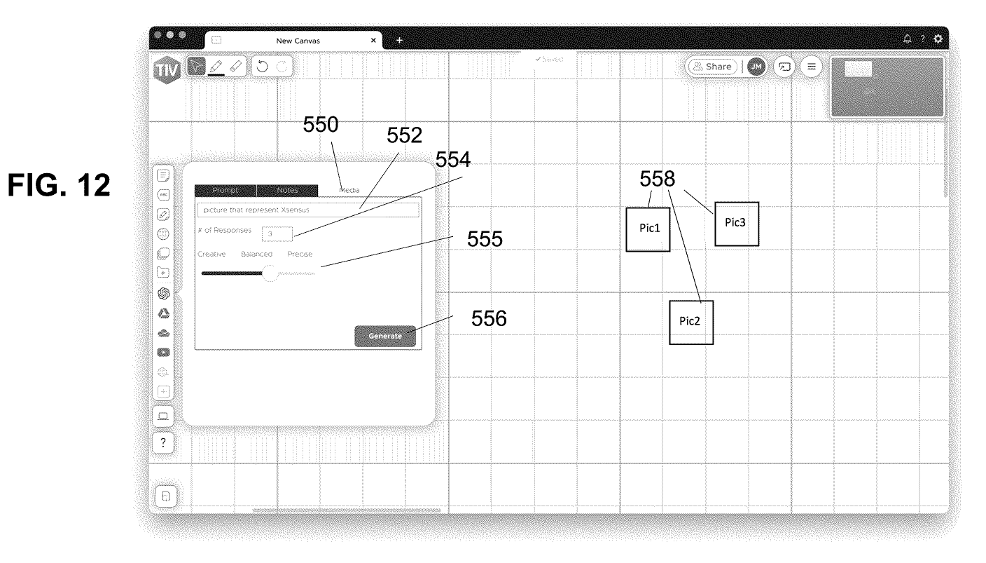

Another alternative is shown in FIG. 9, in which an AI icon 525 includes more alternatives than just inputting a prompt. For example, where the user has access to multiple artificial intelligence (AI) engines, a select AI engine window 520 to allow selection of one or more AI engine by ticking the desired AI engines and hitting a select engine button 522 before proceeding to the prompt options shown in FIGS. 10-12. Alternatively, a user may need to be logged into a single AI engine or use a default AI engine associated with the canvas.

As shown in FIGS. 10-12, the AI icon 525 may present a graphical user interface (GUI) including at least three tabs, e.g. 530, 540, and 550, respectively, in which to type a prompt. As shown in FIG. 10, if only one response to prompt for text from one AI engine is desired, a prompt tab 530 including a prompt entry section 532, a submit button 534, an AI result window 535, and a send to canvas button 536 may be selected. After a user inputs a prompt in the prompt entry section 532 and selects the submit button 534, the AI engine will provide a response in the AI result window 535. If the user wants to send the AI response to the canvas, the user will select the send to canvas button 536, which opens a new notes window 538 displaying the response. Otherwise, the canvas remains unchanged.

If more than one AI engine is to be used or more than one response from an AI engine is desired, a notes tab 540 including a prompt entry section 542, a number of responses entry section 544, a sliding scale of the types of responses wanted 545, and a generated button 546 may be selected. A user will input a prompt in the prompt entry section 542, a number in the number of responses entry section 544, and a range of response in the sliding scale of the types of responses wanted 545, and then select the generate button 546. Unlike the prompt tab 530, selection of the generate button 546 will automatically open a new notes window 548 for each response generated. These multiple windows may then be grouped or sorted as discussed above, e.g., in FIGS. 4-8, and feedback for to the AI engine for further refinement.

If the AI engine is to be used to generate an image, a media tab 550 including a prompt entry section 552, a number of responses entry section 554, a sliding scale of the types of responses wanted 555, and a generated button 536 may be selected. A user will input a prompt in the prompt entry section 542, a number in the number of responses entry section 544, and a range of response in the sliding scale of the types of responses wanted 545, and then select the generate button 546. Unlike the prompt tab 530 and the notes tab 540, selection of the generate button 556 will automatically open media windows 558 for each response generated. These multiple windows may then be grouped or sorted as discussed above, e.g., in FIGS. 4-8, and fed back to the AI engine for further refinement.

Further, while the prompts in FIGS. 10-12 are illustrated as text prompts, a sketch may be used as a prompt for the artificial intelligence engine.

Embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of this disclosure.

The methods and processes described herein may be performed by code or instructions to be executed by a computer, processor, manager, or controller. Because the algorithms that form the basis of the methods (or operations of the computer, processor, or controller) are described in detail, the code or instructions for implementing the operations of the method embodiments may transform the computer, processor, or controller into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, or controller which is to execute the code or instructions for performing the method embodiments described herein.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A method of collaborating between a first computer associated with a first display at a first location and a second computer associated with a second display at a second location, the method comprising:
establishing a connection between the first and second computers;
starting a virtual canvas on the first computer;
sending the virtual canvas from the first computer to the second computer;
in response to an artificial intelligence icon being selected on the first computer or the second computer, open a prompt tab to receive a prompt input, and
in response to the prompt input and activation of a button, generate a response from an artificial intelligence engine in the prompt tab or in a new window on the canvas.

2. The method of claim 1, wherein the prompt input is a text input.

3. The method of claim 1, wherein the prompt input is a sketch.

4. The method of claim 1, wherein each window on the canvas generated from the artificial intelligence engine includes a ranking metric for selection by a user.

5. The method of claim 4, wherein, in response to a user ranking one or more windows on the canvas generated from the artificial intelligence engine, feeding back the ranked windows to the artificial intelligence engine.

6. A method of using an artificial intelligence engine in a virtual canvas running on a computer associated with a display, the method comprising:
starting a virtual canvas on the computer;
in response to an artificial intelligence icon being selected in an icon window of the virtual canvas, open a prompt tab to receive a prompt input, and
in response to the prompt input and activation of a button, generate a response from an artificial intelligence engine in the prompt tab or in a new window on the canvas.

7. The method of claim 6, wherein the prompt input is a text input.

8. The method of claim 6, wherein the prompt input is a sketch.

9. The method of claim 6, wherein each window on the canvas generated from the artificial intelligence engine includes a ranking metric for selection by a user.

10. The method of claim 9, wherein in response to a user ranking one or more windows on the canvas generated from the artificial intelligence engine, feeding back the ranked windows to the artificial intelligence engine.

11. A graphical user interface for using an artificial intelligence engine in a virtual canvas running on a computer associated with a display, the graphical user interface being displayed in response to an artificial intelligence icon being selected in an icon window of the virtual canvas, the graphical user interface comprising:
a prompt tab for inputting a single prompt to retrieve a single text result from an artificial intelligence engine;
a notes tab for inputting a single prompt to retrieve more than one text result from the artificial intelligence engine; and
a media tab for inputting a single prompt to retrieve one or more images from the the artificial intelligence engine.

12. The graphical user interface as claimed in claim 11, wherein,
in response to the prompt being input to the prompt tab, display the single text result in the prompt tab,
in response to the prompt being input to the notes tab, display reach text result in a separate window on the canvas, and
in response to the prompt being input to the media tab, display each image result in a separate window on the canvas.
